(19) United States
(12) Patent Application Publication
(10) Pub. No.: US 2018/0231008 A1
(43) Pub. Date: Aug. 16, 2018

(54) FAN UNIT, METHOD OF MANUFACTURING SAME AND MOTOR DRIVE DEVICE

(71) Applicant: FANUC CORPORATION, Yamanashi (JP)

(72) Inventors: Kazuhiro YAMAMOTO, Yamanashi (JP); Makoto TAKESHITA, Yamanashi (JP)

(73) Assignee: FANUC CORPORATION, Yamanashi (JP)

(21) Appl. No.: 15/887,451

(22) Filed: Feb. 2, 2018

(30) Foreign Application Priority Data
Feb. 15, 2017 (JP) 2017-026116

(51) Int. Cl. F04D 25/06; H02K 5/22; H02K 5/10; H02K 3/30; H02K 15/12; H02K 15/14; F04D 29/52

(52) U.S. Cl. CPC F04D 25/0693; H02K 5/225; H02K 5/10; F04D 29/522; H02K 15/12; H02K 15/14; H02K 3/30

(57) ABSTRACT

An object of the present invention is to provide a fan unit, a motor drive device and a method of manufacturing the fan unit in which an assembly operation is facilitated by use of a small number of components, and in which thus it is possible to reduce the cost thereof. A fan unit includes: a fan which includes a motor and a casing; a base portion to which the fan is fixed by fixing of the casing; and a connector portion which can be connected to an external terminal for supplying power to the motor and which includes a conductive contact and a housing that is formed integrally with the base portion.

### BACKGROUND OF THE INVENTION

This application is based on and claims the benefit of priority from Japanese Patent Application No. 2017-026116, filed on 15 Feb. 2017, the content of which is incorporated herein by reference.

### FIELD OF THE INVENTION

The present invention relates to a fan unit, a method of manufacturing it and a motor drive device.

### RELATED ART

Conventionally, a cartridge type fan unit is known which is removable with respect to a motor drive device. The fan unit is attached to a body of the motor drive device. The fan unit is used for cooling the individual portions of the motor drive device. The fan unit cools, for example, a heatsink which is provided on the outer peripheral surface of the body. In this way, the fan unit can cool a power semiconductor device.

The fan unit is generally formed with a plurality of constituent components. For example, the fan unit is formed by attaching a fan to a base, combining a separation plate therewith and thereafter further attaching a connector to the separation plate. By contrast, a fan unit is proposed in which a base and a separation plate are integrally formed, and in which thus the number of components is reduced (see, for example, Patent Document 1).
Patent Document 1: Japanese Unexamined Patent Application, Publication No. H09-331176

### SUMMARY OF THE INVENTION

In the fan unit proposed in Patent Document 1, although the base and the separation plate are integrally formed, it is necessary to additionally combine a connector. Hence, it is necessary to manufacture the base and the separation plate and the connector as separate components, and thus an assembly operation is needed. Hence, it is preferable to facilitate the operation by use of a smaller number of components.

An object of the present invention is to provide a fan unit, a motor drive device and a method of manufacturing the fan unit in which an assembly operation is facilitated by use of a small number of components, and in which thus it is possible to reduce the cost thereof.

(1) The present invention relates to a fan unit (for example, a fan unit 1 which will be described later) that includes: a fan (for example, a fan 10 which will be described later) which includes a motor (for example, a motor 11 which will be described later) and a casing (for example, a casing 12 which will be described later); a base portion (for example, a base portion 20 which will be described later) to which the fan is fixed by fixing of the casing; and a connector portion (for example, a connector portion 30 which will be described later) which can be connected to an external terminal for supplying power to the motor and which includes a conductive contact (for example, a contact 320 which will be described later) and a housing (for example, a housing 310 which will be described later) that is formed integrally with the base portion.

(2) In the fan unit described in (1) above, the casing may be formed integrally with the base portion.

(3) The fan unit described in (1) or (2) above may further include: a through hole (for example, a through hole 40 which will be described later) which penetrates the base portion; and a connection conductor (for example, a connection conductor 50 which will be described later) which is passed through the through hole so as to electrically connect the contact and the motor together, where the fan unit may have a seal structure in which the through hole is sealed in a state where the connection conductor is passed through the through hole.

(4) In the fan unit described in (3) above, the seal structure may include a seal member (for example, a seal member 60 which will be described later) which seals the through hole in the state where the connection conductor is passed through the through hole.

(5) The fan unit described in (1) or (2) above may further include a connection conductor which electrically connects the contact and the motor together and which is insert-molded into the base portion.

(6) In the fan unit described in any one of (1) to (5) above, the motor may include a rotor (for example, a rotor 15 which will be described later) and a stator (for example, a stator 14 which will be described later), and at least part of the surface of the stator may be coated with a resin (for example, a resin R which will be described later).

(7) A method of manufacturing a fan unit according to the present invention relates to a method of manufacturing a fan unit that includes: a fan which includes a motor and a casing; a base portion to which the fan is fixed by fixing of the casing; a connector portion which can be connected to an external terminal for supplying power to the motor and which includes a conductive contact and a housing that is formed integrally with the base portion; and a conductive connection conductor which connects the contact and the motor together. The method includes: a molding step of insert-molding the contact and the connection conductor into the base portion and the housing; a connection step of electrically connecting a stator of the motor and the connection conductor together; and a coating step of coating at least part of a surface of the stator with a resin.

(8) In the method of manufacturing a fan unit described in (7) above, the connection step may be performed after the molding step, and the coating step may be performed after the connection step.

(9) In the method of manufacturing a fan unit described in (7) above, the coating step may be performed after the connection step, and the molding step may be performed after the coating step.

(10) In the method of manufacturing a fan unit described in (7) above, the connection step may be performed after the coating step and the molding step.

(11) In the fan unit described in any one of (1) to (6) above, the motor may include a rotor which is formed with a bottom-equipped cylindrical portion (for example, a bottom-equipped cylindrical portion 151 which will be described later) that is rotated about an axis line and that is arranged by insertion of a stator, the fan may include a plurality of blades (for example, blades 18 which will be described later) which are provided so as to protrude in a radial direction from an outer peripheral surface of the bottom-equipped cylindrical portion and which are aligned in a peripheral direction of the bottom-equipped cylindrical portion and the casing may include: a frame portion (for example, a frame portion 122 which will be described later) which surrounds an outer periphery of the blades; a disc portion (for example, a disc portion 123 which will be described later) which is provided on a side of the stator; and a stay (for example, a stay 124 which will be described later) which is extended out in the radial direction from an outer peripheral edge portion of the disc portion, is connected to the frame portion and is arranged on an upstream side with respect to the blades in a blowing direction (for example, a blowing direction F which will be described later) of a gas.

(12) In the fan unit described in (11) above, at least one of the disc portion and the stay may include an inclination portion (for example, an inclination portion 125 which will be described later) which is inclined outward in the radial direction toward a side opposite to the blowing direction of the gas.

(13) In the fan unit described in (11) or (12) above, a surface of the stay on the upstream side may be inclined with respect to a direction of the axis line.

(14) A motor drive device (for example, a motor drive device 80 which will be described later) according to the present invention relates to a motor drive device that includes: the fan unit described in any one of (1) to (6) and (11) to (13) above; and a motor drive device main body (for example, a motor drive device main body 90 which will be described later) to which the fan unit is removably attached.

(15) The motor drive device described in (14) above may include: a first body (for example, a first body 91 which will be described later) which is arranged on a side (for example, a space L which will be described later) of one surface of a power magnetics cabinet (for example, a power magnetics cabinet 96 which will be described later); a second body (for example, a second body 92 which will be described later) which is arranged on a side (for example, a space K which will be described later) of the other surface of the power magnetics cabinet, which is aligned with the first body and which a heatsink (for example, a heatsink 95 which will be described later) is arranged outside; and a separation member (for example, a separation member 93 which will be described later) which separates the side of the one surface of the power magnetics cabinet and the side of the other surface of the power magnetics cabinet and which has an opening (for example, an opening 94 which will be described later), where the base portion to which the fan is fixed may be arranged adjacent to the heatsink in a state where the base portion is inserted from a side of the first body into the opening, and the housing may be arranged on the side of the one surface of the power magnetics cabinet.

In the present invention, it is possible to provide a fan unit, a motor drive device and a method of manufacturing the fan unit in which an assembly operation is facilitated by use of a small number of components, and in which thus it is possible to reduce the cost thereof.

### BRIEF DESCRIPTION OF THE DRAWINGS

FIG. 1 is a perspective view showing a fan unit according to a first embodiment of the present invention;

FIG. 2 is a plan view showing the fan unit in the first embodiment;

FIG. 3 is a side view showing the fan unit in the first embodiment and is a diagram of FIG. 1 indicated by an arrow A;

FIG. 4 is a perspective view showing the fan unit in the first embodiment and is a perspective view in a state where a seal member is removed from a base portion;

FIG. 5 is a perspective view showing a fan unit in a third embodiment;

FIG. 6 is a perspective view showing a fan unit in a fourth embodiment;

FIG. 7 is a cross-sectional view taken along line B-B of FIG. 6;

FIG. 8 is a perspective view showing a stator 14, a contact and a connection conductor before insert molding in a method of manufacturing a fan unit in a sixth embodiment;

FIG. 9 is a perspective view in which the stator 14, the contact and the connection conductor are insert-molded into a base portion in the method of manufacturing the fan unit in the sixth embodiment;

FIG. 10 is a cross-sectional view taken along line C-C of FIG. 9;

FIG. 11 is a perspective view in which the stator 14 is fixed in the method of manufacturing the fan unit in the sixth embodiment;

FIG. 12 is a perspective view of the fan unit in which the surface of the stator 14 is coated with a resin in the method of manufacturing the fan unit in the sixth embodiment;

FIG. 13 is a perspective view showing a fan in the fan unit of a ninth embodiment;

FIG. 14 is a cross-sectional view taken along line D-D of FIG. 13;

FIG. 15 is a cross-sectional view taken along line E-E of FIG. 13;

FIG. 16 is a perspective view showing a motor drive device according to a tenth embodiment;

FIG. 17 is a perspective view in which a fan unit is removed from a motor drive device main body according to the tenth embodiment; and

FIG. 18 is a schematic side view showing the motor drive device according to the tenth embodiment.

### DETAILED DESCRIPTION OF THE INVENTION

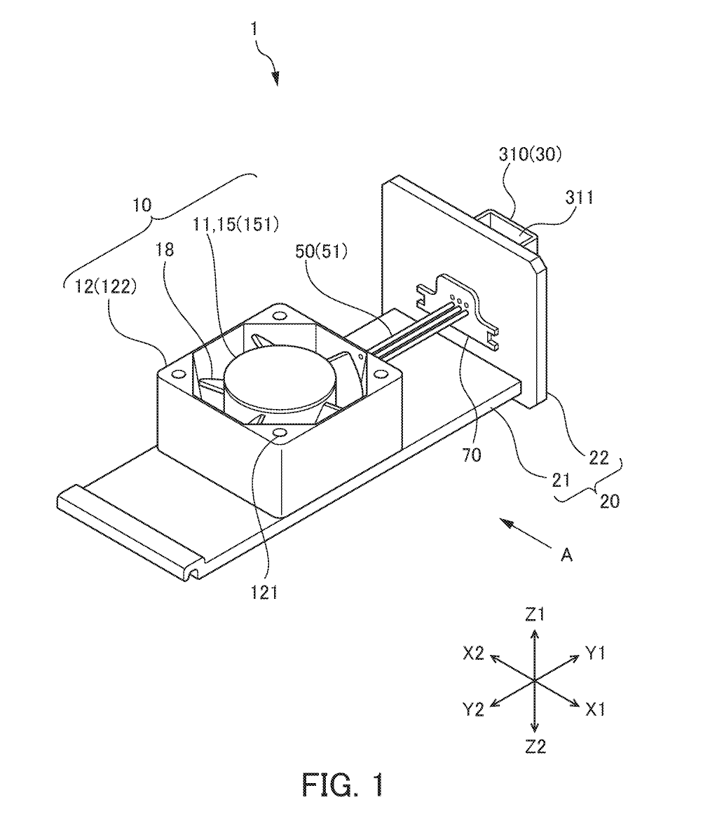

Embodiments of a fan unit, a method of manufacturing the fan unit and a motor drive device according to the present invention will be described below with reference to FIGS. 1 to 18.

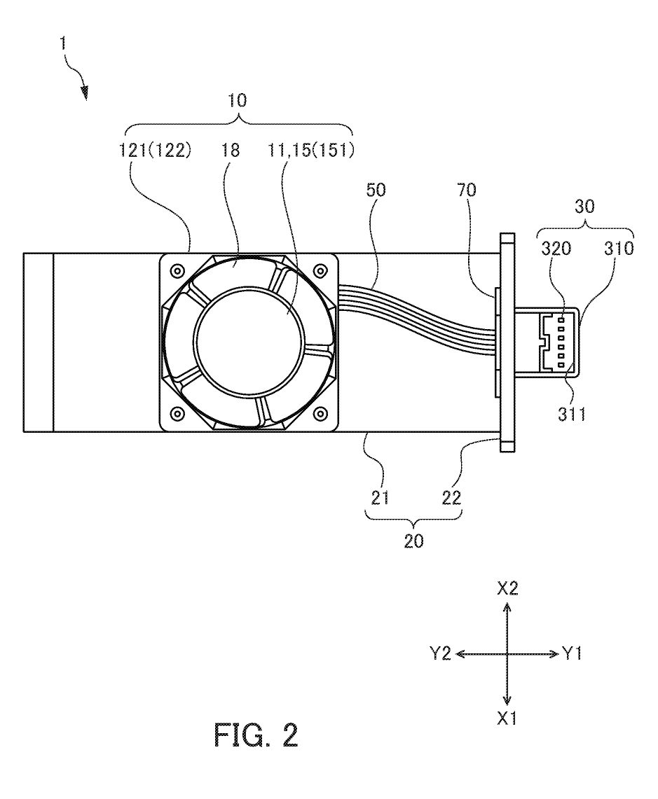

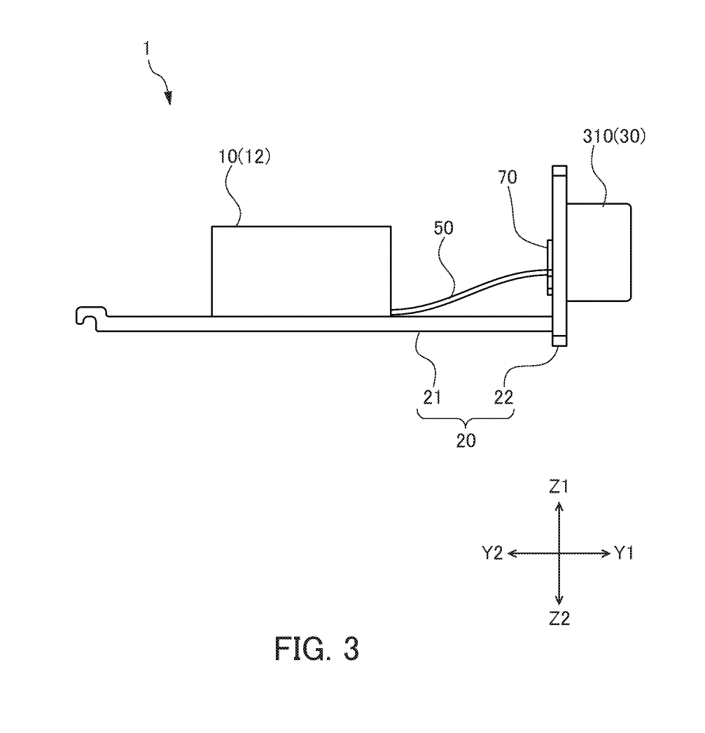

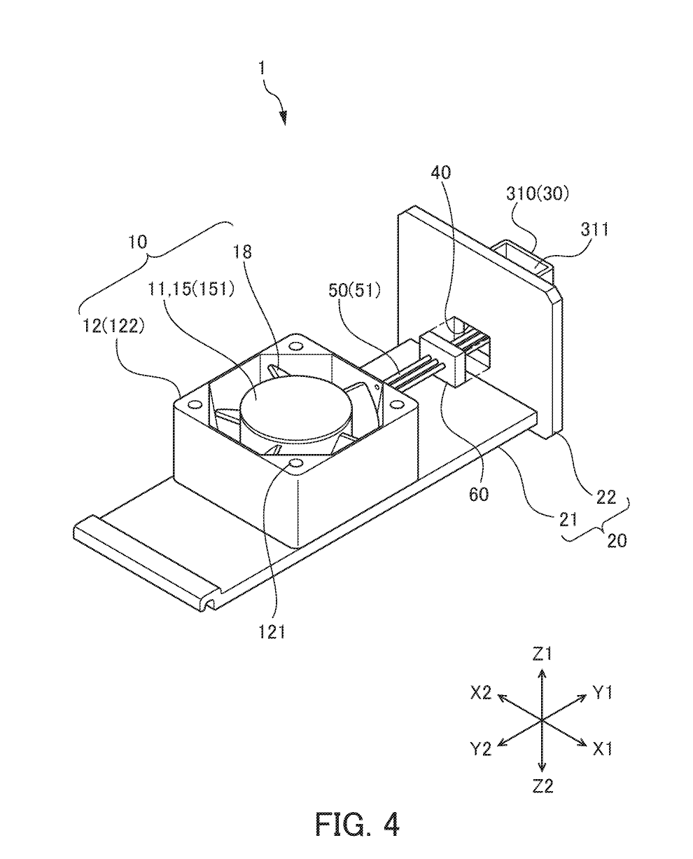

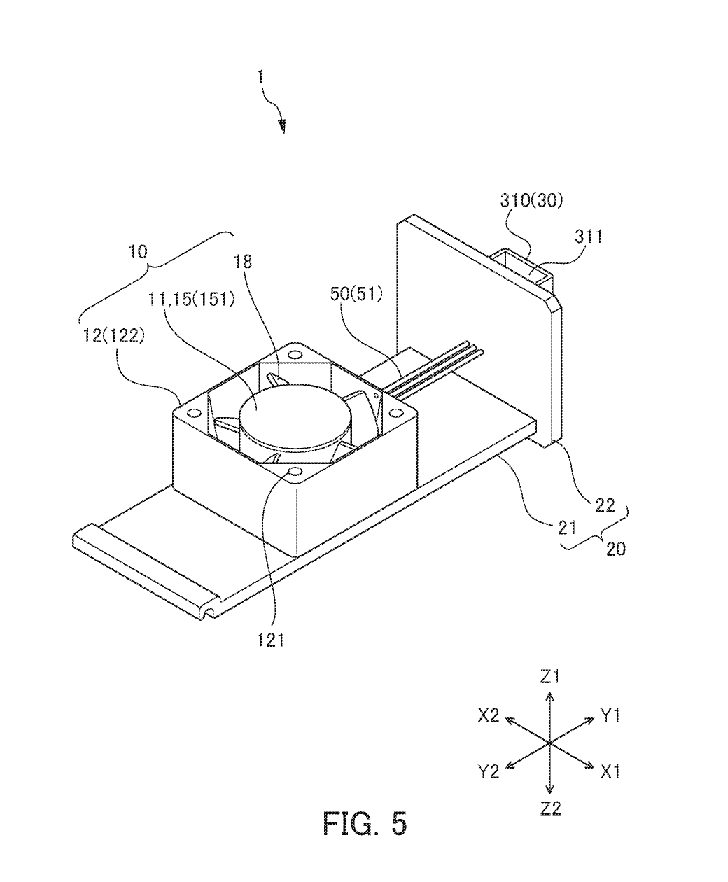

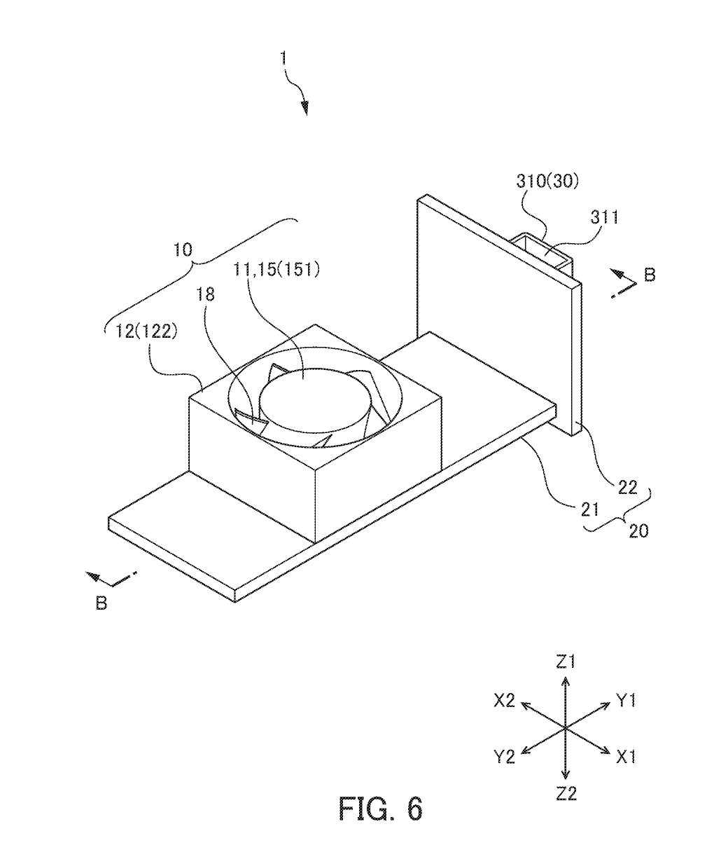

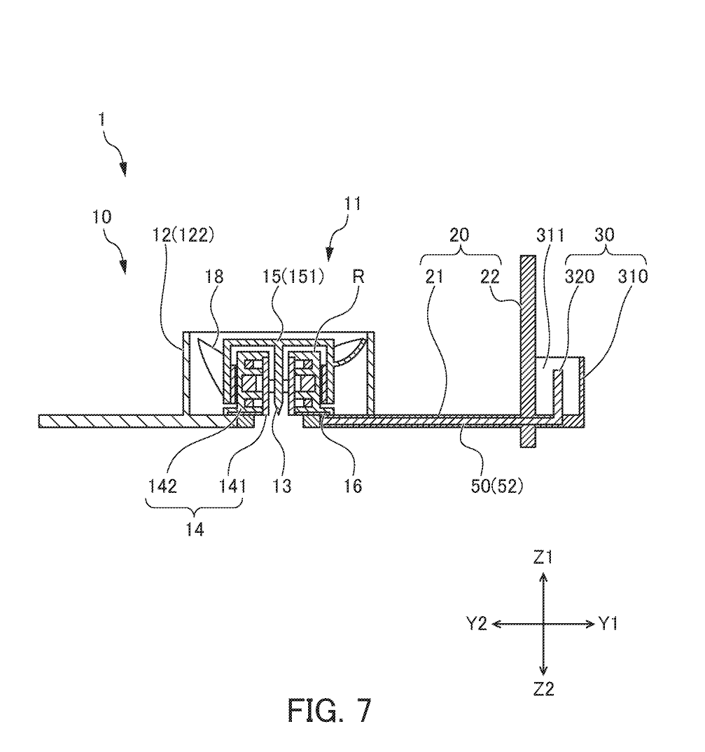

FIG. 1 is a perspective view showing a fan unit according to a first embodiment of the present invention. FIG. 2 is a plan view showing the fan unit in the first embodiment. FIG. 3 is a side view showing the fan unit in the first embodiment and is a diagram of FIG. 1 indicated by an arrow A. FIG. 4 is a perspective view showing the fan unit in the first embodiment and is a perspective view in a state where a seal member is removed from a base portion. FIG. 5 is a perspective view showing a fan unit in a third embodiment. FIG. 6 is a perspective view showing a fan unit in a fourth embodiment. FIG. 7 is a cross-sectional view taken along line B-B of FIG. 6.

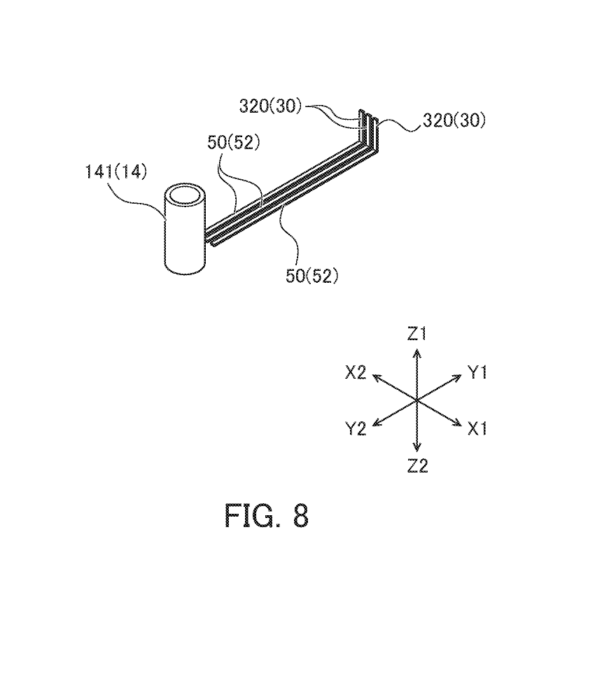

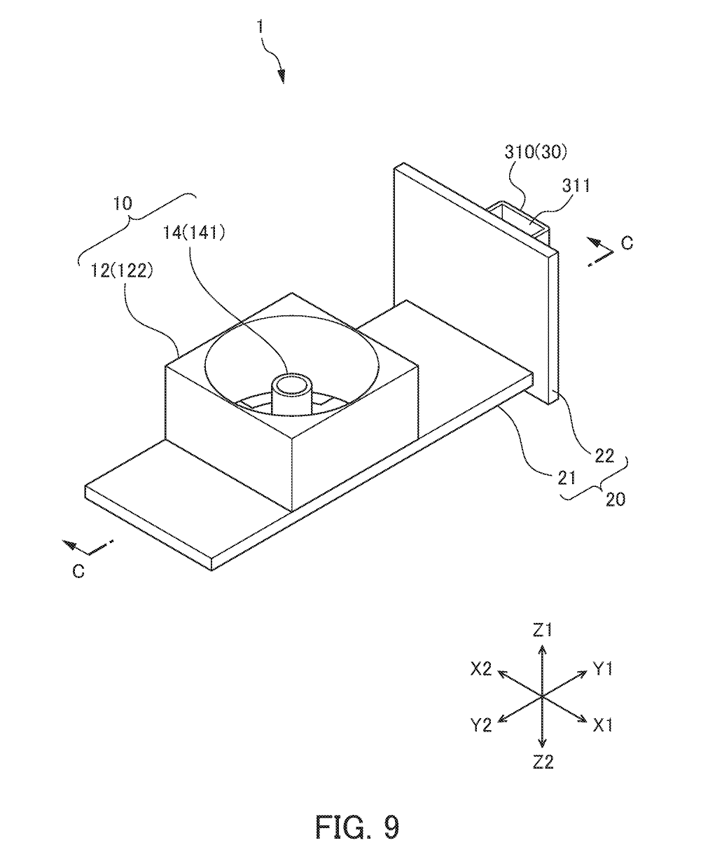

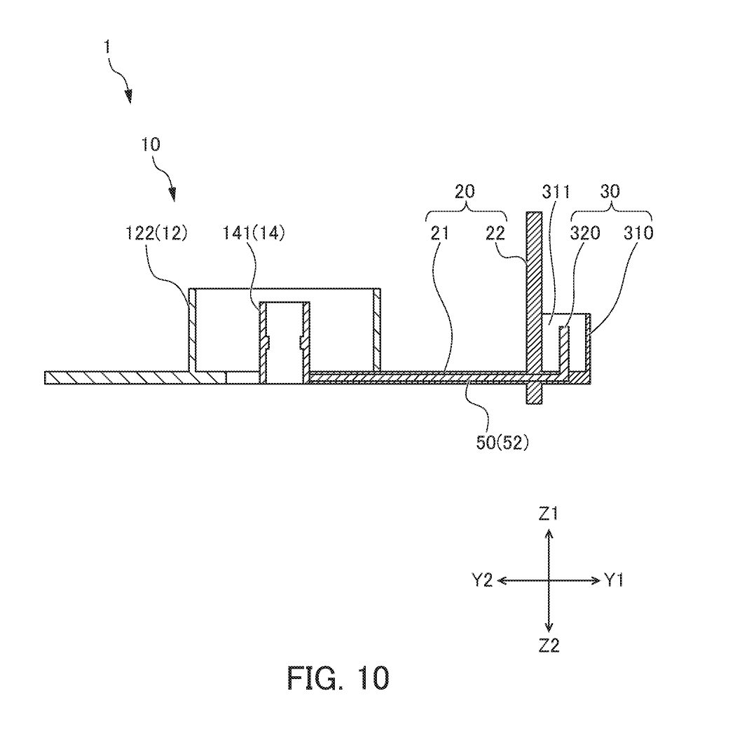

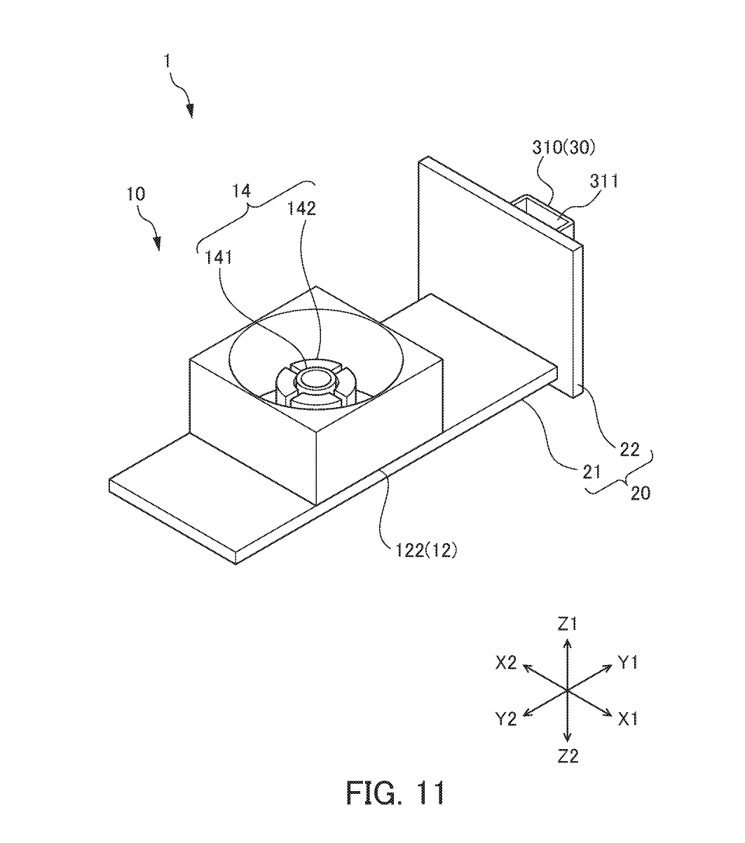

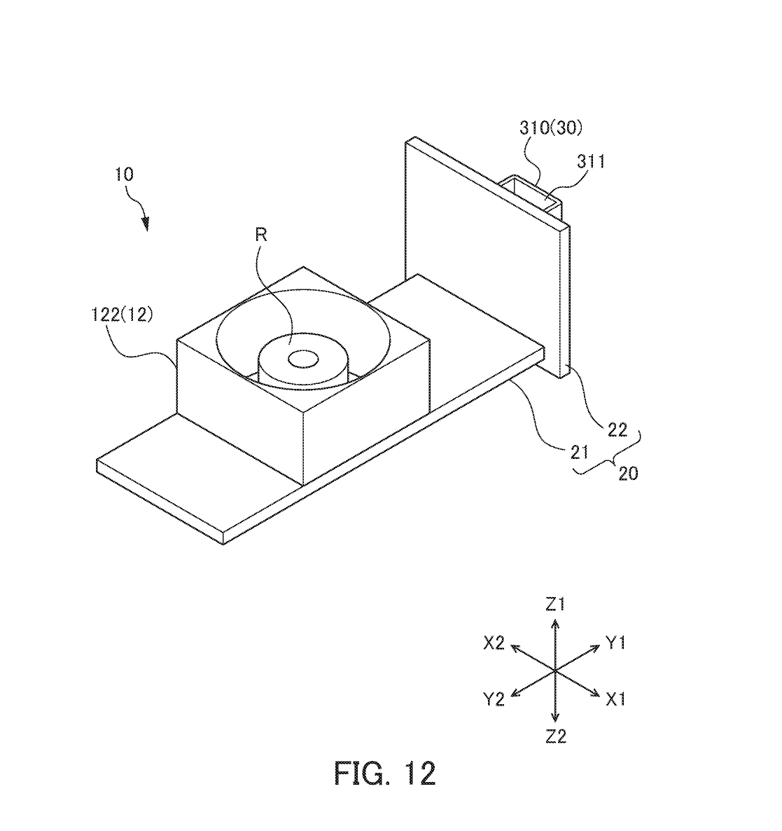

FIG. 8 is a perspective view showing a stator, a contact and a connection conductor before insert molding in a method of manufacturing a fan unit in a sixth embodiment. FIG. 9 is a perspective view in which the stator, the contact and the connection conductor are insert-molded into a base portion in the method of manufacturing the fan unit in the sixth embodiment. FIG. 10 is a cross-sectional view taken along line C-C of FIG. 9. FIG. 11 is a perspective view in which the stator is fixed in the method of manufacturing the fan unit in the fourth embodiment. FIG. 12 is a perspective view of the fan unit in which the surface of the stator is coated with a resin in the method of manufacturing the fan unit in the fourth embodiment.

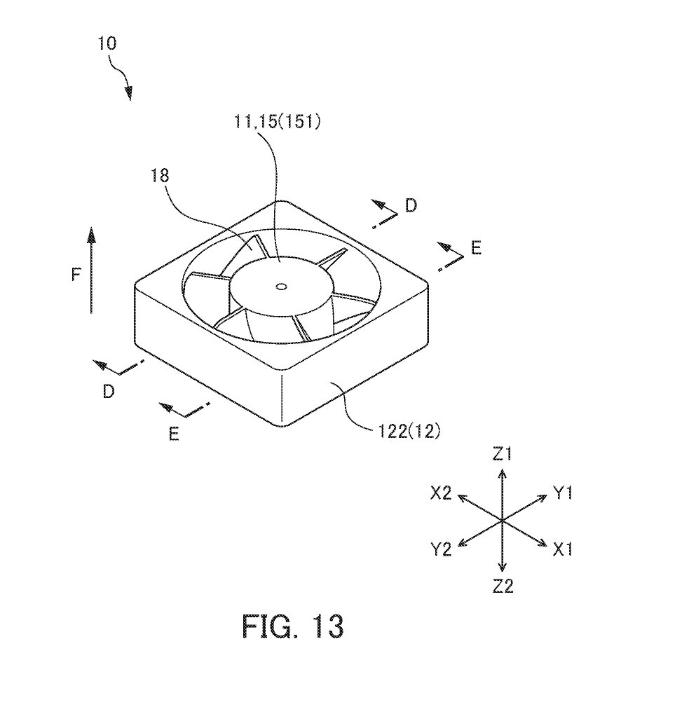

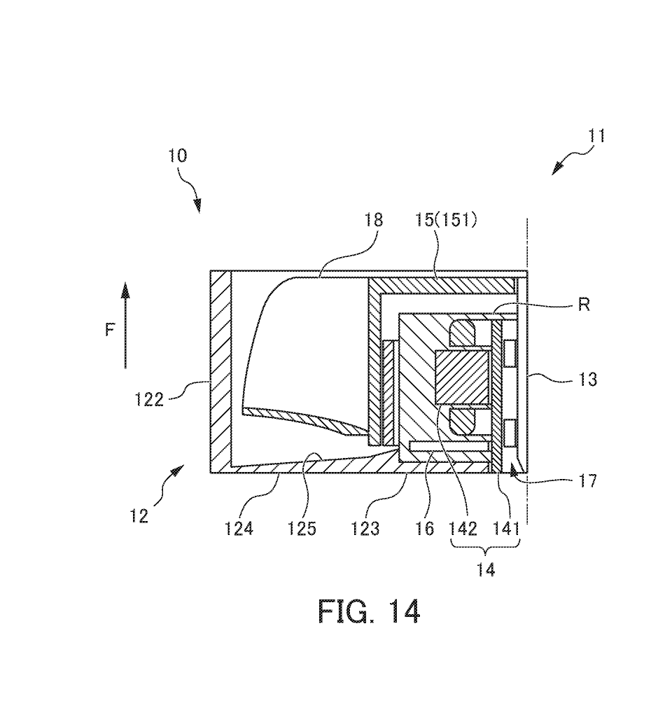

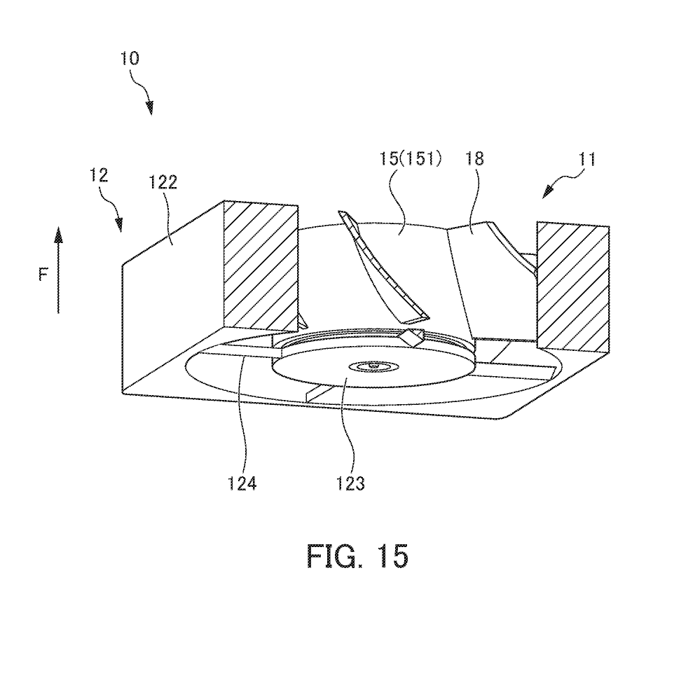

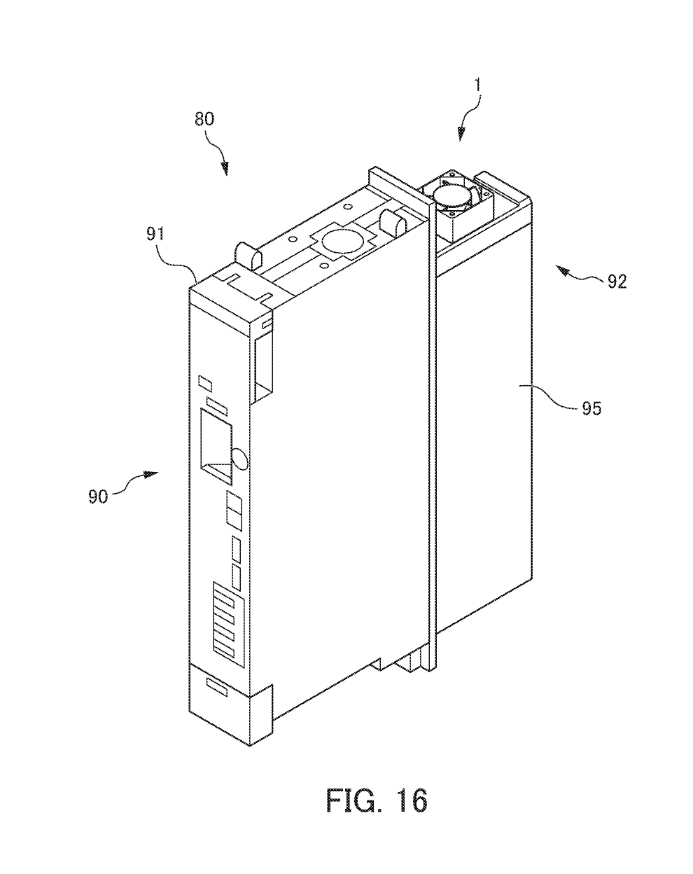

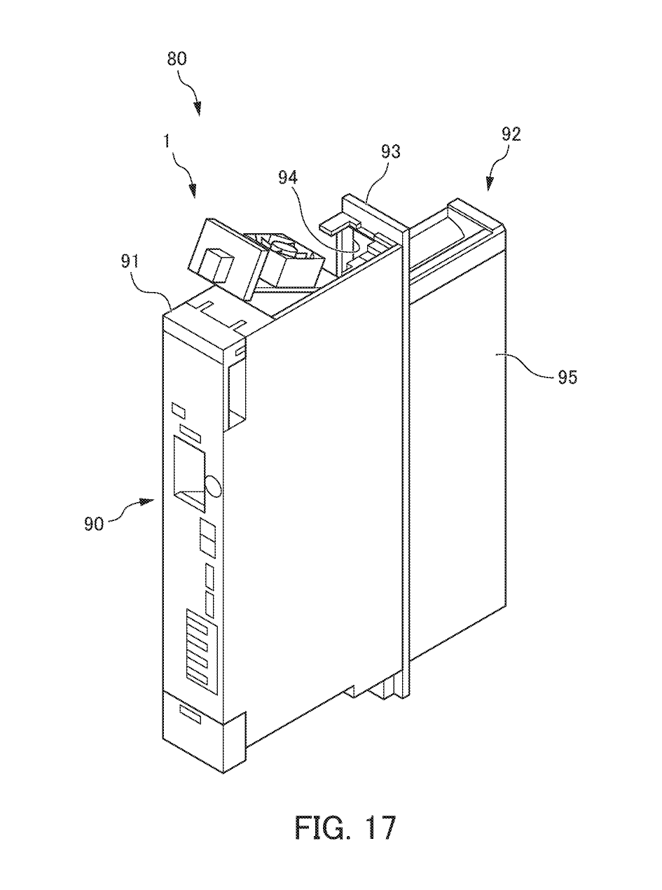

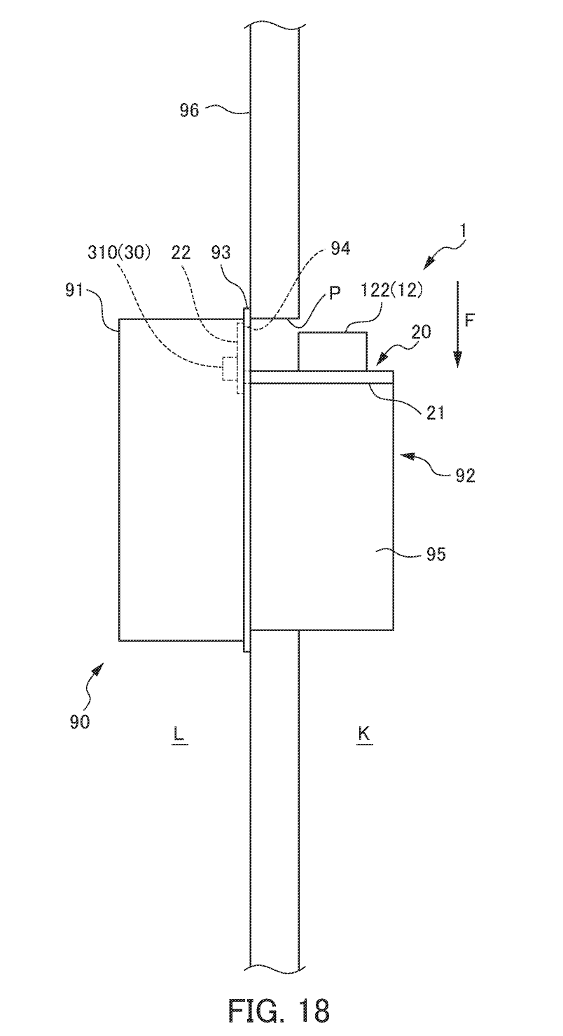

FIG. 13 is a perspective view showing a fan in the fan unit of a seventh embodiment. FIG. 14 is a cross-sectional view taken along line D-D of FIG. 13. FIG. 15 is a cross-sectional view taken along line E-E of FIG. 13. FIG. 16 is a perspective view showing a motor drive device according to an eighth embodiment. FIG. 17 is a perspective view in which a fan unit is removed from a motor drive device main body in the eighth embodiment. FIG. 18 is a schematic side view showing a motor drive device according to a tenth embodiment.

The drawings attached to the present specification are schematic views, and with consideration given to ease of understanding and the like, the shapes, the scales, the dimensional ratios in vertical and lateral directions and the like of the actual objects are changed or exaggerated. In the drawings, hatching indicating the cross section of a member is omitted as necessary.

In the present specification and the like, it is assumed that one lateral direction of the fan unit 1 is an X (X1-X2) direction, and that a lateral direction orthogonal to the X direction is a Y (Y1-Y2) direction. It is also assumed that a direction of thickness of the fan unit 1 (the direction orthogonal to an X-Y plane) is a Z (Z1-Z2) direction.

The fan unit 1 is a device which forcefully cools various types of devices that are cooling targets by spraying a surrounding gas thereto. For example, the fan unit 1 is used by being attached to an electronic device, a heatsink or the like. In the embodiments below, the fan unit 1 (see FIGS. 16 to 18) which is part of a motor drive device 80 will be described as an example. In the embodiments below, the fan unit 1 (see FIGS. 16 to 18) which cools a heatsink 95 in the motor drive device 80 will be described as an example.

### First Embodiment

A fan unit 1 according to the first embodiment of the present invention will first be described with reference to FIGS. 1 to 4. As shown in FIGS. 1 to 4, the fan unit 1 according to the present embodiment is connected to an external terminal (unillustrated), and thus power is supplied from the outside, with the result that the fan unit 1 is operated. The fan unit 1 includes a fan 10, a base portion 20, a connector portion 30, a through hole 40, a connection conductor 50, a seal member 60 and a holding member 70.

As shown in FIG. 1, the fan 10 is formed substantially in the shape of a rectangular parallelepiped. The fan 10 can distribute (blow) a gas in the Z direction. The fan 10 includes a motor 11, a plurality of blades 18 and a casing 12.

The motor 11 includes a rotary shaft 13 (see FIG. 14), a stator 14 (see FIG. 14), a rotor 15, a bearing 17 (see FIG. 14) and a printed board 16 (see FIG. 14). The rotary shaft 13 is a rod-shaped member. In the present embodiment, the rotary shaft 13 and the rotor 15 are arranged such that the axial directions thereof are along the Z direction.

The stator 14 includes a bearing holder 141 (see FIG. 14) which holds the bearing 17 and a stator main body 142 (see FIG. 14). At least part of the surface of the stator 14 is coated with a resin R. The bearing holder 141 is formed in the shape of a cylinder. The stator main body 142 is arranged along the outer peripheral surface of the bearing holder 141.

The rotor 15 includes a bottom-equipped cylindrical portion 151 (see FIG. 14). The bottom-equipped cylindrical portion 151 is fixed to the rotary shaft 13 at its bottom portion. The stator 14 is inserted into the bottom-equipped cylindrical portion 151 so as to be arranged. Specifically, the bottom-equipped cylindrical portion 151 is arranged in a state where the bottom portion is fixed to the rotary shaft 13 and where the inner surface thereof is opposite to the stator 14 with the bearing 17 therebetween.

The bearing 17 is arranged so as to be interposed between the outer surface of the rotary shaft 13 and the inner surface of the bearing holder 141 in the stator 14, and the bearing 17 rotatably holds the rotary shaft 13 with respect to the stator 14.

The blades 18 are provided so as to be protruded from the outer peripheral surface of the bottom-equipped cylindrical portion 151 in a radial direction. The blades 18 are provided so as to be aligned in the peripheral direction of the bottom-equipped cylindrical portion 151.

The stator 14 is mounted on the printed board 16. The printed board 16 is provided in order to supply drive power to the stator 14. The printed board 16 is arranged such that the direction of the board surface is along the X-Y plane.

The casing 12 is arranged so as to surround the peripheral direction of the rotary shaft 13 in the motor 11. The casing 12 is formed substantially in the shape of a rectangle having an opening in the center when seen in the Z2 direction. The Z2 direction is a direction which extends from the casing 12 toward a first portion 21 (which will be described later) of the base portion 20. In the present embodiment, attachment holes 121 which penetrate in the Z direction are formed in the vicinity of the four corners of the casing 12. In the case of a form in which the fixing is performed by a method other than screwing, the attachment holes 121 are not needed.

The base portion 20 is a portion which fixes the fan 10 by the fixing of the casing 12. As shown in FIG. 1, the base portion 20 includes the first portion 21 and a second portion 22.

The first portion 21 is formed of an insulating material. The first portion 21 is formed of, for example, a resin. The first portion 21 is formed in the shape of a plate. In the present embodiment, the first portion 21 is formed in the shape of the plate which is extended along the X-Y plane. In the present embodiment, the first portion 21 is formed in the shape of a rectangle when seen in the Z direction. In the first portion 21, a blowing hole (unillustrated) which penetrates in the Z direction is formed so as to correspond to the position in which the fan 10 is fixed. In the blowing by the fan 10, the gas is sprayed through the blowing hole to the heatsink 95 which is located on a side opposite to the fan 10 in the first portion 21 of the base portion 20.

The second portion 22 is coupled to the first portion 21. The second portion 22 is formed integrally with the first portion 21. In the present embodiment, the second portion 22 is formed of the same resin as the first portion 21. The second portion 22 is extended from one end portion of the first portion 21 in the Z1 direction. Specifically, the second portion 22 is formed in the shape of a plate which is extended from the one end portion of the first portion 21 in the Z1 direction. The second portion 22 is formed in the shape of a rectangle when seen in the Y direction. The second portion 22 is attached to the motor drive device so as to separate between an atmosphere on the side of the fan 10 (the Y2 side) and an atmosphere on the side of the connector portion 30 (the Y1 side). In the present embodiment, an angle formed by the first portion 21 and the second portion 22 is 90 degrees (right angle). The angle formed is not limited to 90 degrees.

The connector portion 30 can be connected to the external terminal for supplying power to the motor 11. The connector portion 30 includes a housing 310 and a contact 320.

The housing 310 is formed integrally with the base portion 20. Specifically, the housing 310 is formed integrally with the second portion 22. As shown in FIGS. 1 to 3, the housing 310 is provided on a surface (the surface on the Y1 side) opposite to the surface (the surface on the Y2 side) opposite to the fan 10 in the second portion 22. The housing 310 is formed in the shape of a rectangular parallelepiped which has an opening 311 that is opened in the Z1 direction. In the present embodiment, the housing 310 is formed of the resin of the same material as the second portion 22.

The contact 320 is a rod-shaped member. The contact 320 is formed of a conductive material. In the present embodiment, the contact 320 is a plurality of rod-shaped members which are aligned in the X direction. The contact 320 is insert-molded into the housing 310. The contact 320 is arranged such that one end thereof is exposed from the inner surface of the housing 310. The one end of the contact 320 is directed in the Z1 direction.

The through hole 40 penetrates the base portion 20. In the present embodiment, the through hole 40 penetrates the second portion 22 in the direction of thickness thereof (the Y direction). The through hole 40 is formed in the shape of a rectangle when seen in the Y direction. In the present embodiment, the through hole 40 penetrates so as to correspond to the position of the other end of the contact 320. In this way, the through hole 40 exposes the other end of the contact 320 to the side of the surface (the surface on the Y2 side) opposite to the fan 10 in the second portion 22.

The connection conductor 50 electrically connects the contact 320 and the motor 11 together. In the present embodiment, the connection conductor 50 is a conductive cable 51, and is formed with a conductive core wire (unillustrated) and a resin with which the core wire is coated. The connection conductor 50 is passed through the through hole 40 so as to be arranged. One end of the connection conductor 50 is connected to the other end of the contact 320. The other end of the connection conductor 50 is connected to the motor 11.

The seal member 60 is formed of, for example, a resin. As shown in FIG. 4, the seal member 60 is formed in the shape of a rectangle when seen in the direction of the thickness (the Y direction) so as to correspond to the shape and the size of the through hole 40. The seal member 60 has an insertion hole (unillustrated) through which the connection conductor 50 can be passed in the direction of the thickness (the Y direction). The seal member 60 is arranged within the through hole 40 in a state where the connection conductor 50 is passed therethrough. Since in the state where the connection conductor 50 is passed through the insertion hole, the insertion hole is filled, ventilation through the insertion hole is practically interrupted.

The holding member 70 is formed of, for example, a resin. The holding member 70 is formed in the shape of, for example, a plate. The holding member 70 is formed, for example, so as to have a size capable of covering the through hole 40. The holding member 70 is fixed to the second portion 22 in a state where the holding member 70 is overlaid on the seal member 60 arranged within the through hole 40. In this way, the seal member 60 is held in the through hole 40. The holding member 70 has an insertion hole (unillustrated) through which the connection conductor 50 can be passed in the direction of the thickness (the Y direction).

The fan unit 1 described above is operated as follows. The connector portion 30 is first connected to the external terminal. Specifically, the housing 310 holds the external terminal which is inserted through the opening 311. The contact 320 is electrically connected to the contact of the external terminal.

The power supplied from the external terminal is supplied to the motor 11 through the contact 320 of the connector portion 30 and the connection conductor 50. The motor 11 is rotated by the supplied power. When the motor 11 is rotated, the fan 10 blows in the Z1 or Z2 direction through the blowing hole (unillustrated) in the first portion 21 of the base portion 20.

Here, the holding member 70 is fixed to the second portion 22 in the state where the holding member 70 is overlaid on the seal member 60, and thus the seal member 60 is held in a state where the seal member 60 seals the through hole 40. In this way, the seal member 60 interrupts the distribution of the gas between the atmosphere on the side where the fan 10 is provided (the Y2 side) and the atmosphere on the side where the connector portion 30 is provided (the Y1 side).

A method of manufacturing the fan unit 1 will then be described. The base portion 20 and the housing 310 are first formed by injection molding. In other words, the first portion 21, the second portion 22 and the through hole 40 are integrally formed.

Then, the fan 10 is fixed to the surface on the Z1 side of the first portion 21. The fan 10 is screwed to the first portion 21 with, for example, bolts (unillustrated) which are inserted through the attachment holes 121. Then, the contact 320 which connects the connection conductor 50 is passed through the seal member 60. The connection conductor 50 is then passed through the through hole 40 so as to be electrically connected between the contact 320 and the motor 11.

The seal member 60 is inserted into the through hole 40 from the surface on the Y2 side of the second portion 22. Then, the holding member 70 is fixed to the second portion 22 in the state where the holding member 70 is overlaid on the seal member 60.

According to the fan unit 1 of the present embodiment, for example, the following effects are produced.

(1) A fan unit 1 includes: a fan 10 which includes a motor 11 and a casing 12; a base portion 20 to which the fan 10 is fixed by fixing of the casing 12; and a connector portion 30 which can be connected to an external terminal for supplying power to the motor 11 and which includes a conductive contact 320 and a housing 310 that is formed integrally with the base portion 20. As described above, the base portion 20 is formed integrally with the housing 310 of the connector portion 30, and thus it is possible to reduce the number of components. Hence, when the fan unit 1 is formed, the operation can be facilitated, and thus it is possible to reduce the cost. Since it is possible to suppress the formation of a gap between the base portion 20 and the housing 310, it is possible to hermetically form a portion between the base portion 20 and the housing 310. In this way, it is possible to suppress the unintentional distribution of the surround atmosphere between the base portion 20 and the housing 310.

### Second Embodiment

A fan unit 1 of a second embodiment according to the present invention will then be described with reference to FIGS. 1 to 4. In the description of the second embodiment and the subsequent embodiments, the same configuration requirements are identified with the same symbols, and the description thereof will be omitted or simplified. The fan unit 1 according to the present embodiment differs from the first embodiment in that the casing 12 of the fan 10 is formed integrally with the base portion 20.

The casing 12 is formed of the same material as the first portion 21 of the base portion 20. The casing 12 is formed by injection molding simultaneously with the base portion 20.

According to the fan unit 1 of the present embodiment, for example, the following effects are produced.

(2) The casing 12 is formed integrally with the base portion 20. In this way, it is possible to further reduce the number of components of the fan unit 1. Hence, when the fan unit 1 is formed, the operation can be more facilitated, and thus it is possible to reduce the cost.

### Third Embodiment

A fan unit 1 according to a third embodiment of the present invention will then be described with reference to FIG. 5. The fan unit 1 according to the present embodiment differs from the first embodiment in that the fan unit 1 does not include the seal member 60 and the holding member 70. As shown in FIG. 5, the fan unit 1 has a seal structure in which the through hole 40 is sealed in a state where the connection conductor 50 is passed through the through hole 40.

The seal structure is formed with the second portion 22 and the connection conductor 50 (the conductive cable 51). The second portion 22 is arranged in contact with the entire peripheral surface of a resin at one end portion of the cable 51.

A method of manufacturing the fan unit 1 will then be described. The other end of the contact 320 and the one end of the cable 51 are arranged in a mold in a state where they are connected together. Then, the base portion 20 and the housing 310 are injection-molded, and thus the contact 320 and the one end portion of the cable 51 are insert-molded into the second portion 22 and the housing 310.

According to the fan unit 1 of the present embodiment, for example, the following effects are produced.

(3) The fan unit 1 has a seal structure in which the through hole 40 is sealed in a state where the connection conductor 50 is passed through the through hole 40. Hence, as compared with a case where the seal structure is formed so as to include the seal member 60 and the holding member 70, the number of components can be further reduced. Hence, when the fan unit 1 is formed, the operation can be more facilitated, and thus it is possible to reduce the cost.

### Fourth Embodiment

A fan unit 1 according to a fourth embodiment of the present invention will then be described with reference to FIGS. 6 and 7. The fan unit 1 according to the present embodiment differs from the first to third embodiments in that the entire connection conductor 50 is insert-molded into the base portion 20.

The connection conductor 50 is formed of the same material as the contact 320, and is, as shown in FIGS. 6 and 7, a metal piece 52 which is formed integrally with the contact 320. From another viewpoint, the metal piece 52 is a rod-shaped member which is obtained by extending the other end of the contact 320. The metal piece 52 is arranged along the Y direction, and is insert-molded into the base portion 20. Then, the metal piece 52 is extended to the position of the motor 11 so as to be arranged.

According to the fan unit 1 of the present embodiment, for example, the following effects are produced.

(4) The fan unit 1 includes a connection conductor 50 which electrically connects the contact 320 and the motor 11 together and which is insert-molded into the base portion 20. In this way, the connection conductor 50 is prevented from being exposed to the outside, and thus it is possible to enhance the reliability of the connection conductor 50. Since the connection conductor 50 is the metal piece 52 which is formed integrally with the contact 320, it is possible to more reduce the number of components. Hence, when the fan unit 1 is formed, the operation can be more facilitated, and thus it is possible to reduce the cost.

### Fifth Embodiment

A fan unit 1 according to a fifth embodiment of the present invention will then be described. The fan unit 1 of the present embodiment differs from the first to fourth embodiments in that at least part of the surface of the stator 14 in the motor 11 is coated with the resin R.

According to the fan unit 1 of the present embodiment, for example, the following effects are produced.

(5) The motor includes a rotor 15 and a stator 14. At least part of a surface of the stator 14 is coated with a resin R. In this way, the adherence of a stain to the stator 14 can be suppressed, and thus it is possible to enhance the reliability of the motor 11.

### Sixth Embodiment

A method of manufacturing the fan unit 1 according to a sixth embodiment of the present invention will then be described with reference to FIGS. 8 to 12. The method of manufacturing the fan unit 1 according to the present embodiment is a method of manufacturing the fan unit 1 according to the fifth embodiment. Hence, the fan unit 1 according to the present embodiment has the same configuration as in the fifth embodiment.

The method of manufacturing the fan unit 1 according to the present embodiment includes an arrangement step, a molding step, a connection step, a coating step and a rotor attachment step. In the arrangement step, as shown in FIG. 8, the contact 320, the connection conductor 50 (the metal piece 52) and the bearing holder 141 are arranged within the mold (unillustrated). Then, in the molding step, the contact 320, the connection conductor 50 and the bearing holder 141 are insert-molded into the housing 310 and the base portion 20. In this way, as shown in FIG. 9, the housing 310, the base portion 20 and the casing 12 are integrally formed, and the contact 320 and the connection conductor 50 are arranged within the housing 310 and the base portion 20. The end portion of the bearing holder 141 on the Z2 side is insert-molded into the first portion 21 of the base portion 20.

Then, in the connection step, the stator 14 of the motor 11 and the connection conductor 50 are electrically connected together. Specifically, as shown in FIGS. 10 and 11, the printed board 16 and the stator main body 142 which are previously produced and integrated are mounted on the bearing holder 141. Then, the printed board 16 and the connection conductor 50 are electrically connected together by, for example, soldering.

Then, in the coating step, at least part of the surface of the stator 14 is coated with the resin R. Specifically, as shown in FIG. 12, the resin R is injected to the surface of the stator 14, and thus the surfaces of the printed board 16 and the stator 14 are coated with the resin R. Here, the resin R is injected to part of the surface of the base portion 20. In this way, it is possible to enhance the rigidity of the stator 14.

Then, in the rotor attachment step, the rotor 15 that includes the rotary shaft 13 to which the bearing 17 is attached and the blades 18 are attached to the stator 14. In this way, it is possible to manufacture, for example, the fan unit 1 shown in FIG. 6.

According to the method of manufacturing the fan unit 1 in the present embodiment, for example, the following effects are produced.

(6) A method of manufacturing the fan unit 1 includes: a molding step of insert-molding the contact 320 and the connection conductor 50 into the base portion 20 and the housing 310; a connection step of electrically connecting a stator 14 of the motor 11 and the connection conductor 50 together; and a coating step of coating at least part of a surface of the stator 14 with a resin. Then, the connection step is performed after the molding step, and the coating step is performed after the connection step. In this way, in a state where the contact 320 and the connection conductor 50 are located, the base portion 20 and the housing 310 can be integrally molded, and thus it is possible to enhance the accuracy of the positions of the contact 320 and the connection conductor 50.

### Seventh Embodiment

A method of manufacturing the fan unit 1 according to a seventh embodiment of the present invention will then be described with reference to FIGS. 8 to 12. The manufacturing method of the present embodiment is achieved by changing the order of the individual steps in the sixth embodiment. Hence, configurations after being individually subjected to the steps differ from those shown in FIGS. 8 to 12, and thus the different portions will be described individually.

The method of manufacturing the fan unit 1 according to the present embodiment differs from the sixth embodiment in that the coating step is performed after the connection step and that the molding step is performed after the coating step. Specifically, first, in the connection step, the stator 14 of the motor 11 and the connection conductor 50 are electrically connected together. Specifically, the printed board 16 and the stator main body 142 which are previously produced and integrated are mounted on the bearing holder 141. Then, the printed board 16 and the connection conductor 50 are electrically connected together by, for example, soldering. In other words, the configurations shown in FIGS. 8 to 11 other than the base portion 20, the housing 310 and the casing 12 are formed.

Then, in the coating step, at least part of the surface of the stator 14 is coated with the resin R. The resin R is injected to the surface of the stator 14, and thus the surfaces of the printed board 16 and the stator 14 are coated with the resin R. In other words, the configuration shown in FIG. 12 other than the base portion 20, the housing 310 and the casing 12 is formed.

Then, in the arrangement step, the contact 320, the connection conductor 50 (the metal piece 52) and the stator 14 coated with the resin R are arranged within the mold (unillustrated). Then, in the molding step, the contact 320, the connection conductor 50 and the stator 14 are insert-molded into the housing 310 and the base portion 20. In this way, as shown in FIG. 12, the housing 310, the base portion 20 and the casing 12 are integrally formed, and the contact 320 and the connection conductor 50 are arranged within the housing 310 and the base portion 20. The end portion of the stator 14 on the Z2 side is insert-molded into the first portion 21 of the base portion 20.

Then, in the rotor attachment step, the rotor 15 that includes the rotary shaft 13 to which the bearing 17 is attached and the blades 18 are attached to the stator 14. In this way, it is possible to manufacture, for example, the fan unit 1 shown in FIG. 6.

According to the method of manufacturing the fan unit 1 in the present embodiment, for example, the following effects are produced.

(7) The coating step is performed after the connection step. The molding step is performed after the coating step. In this way, it is possible to manufacture the fan unit 1 even by another manufacturing method.

### Eight Embodiment

A method of manufacturing the fan unit 1 according to an eighth embodiment of the present invention will then be described with reference to FIGS. 8 to 12. The manufacturing method of the present embodiment is achieved by changing the order of the individual steps in the sixth embodiment. Hence, configurations after being individually subjected to the steps differ from those shown in FIGS. 8 to 12, and thus the different portions will be described individually.

The method of manufacturing the fan unit 1 according to the present embodiment differs from the sixth and seventh embodiments in that the connection step is performed after the coating step and the molding step. Specifically, first, in the coating step, at least part of the surface of the stator 14 is coated with the resin. Specifically, the resin R is injected to the surface of the stator 14, and thus the surfaces of the printed board 16 and the stator 14 are coated with the resin R. In other words, only the portion of the stator 14 in the configuration shown in FIG. 12 is formed. Here, the printed board 16 other than the portion which is electrically connected to the connection conductor 50 is coated with the resin R.

Then, in the arrangement step, the contact 320 and the connection conductor 50 (the metal piece 52) are arranged within the mold (unillustrated). In other words, the configuration shown in FIG. 8 other than the bearing holder 141 is arranged. Then, in the molding step, the contact 320 and the connection conductor 50 are insert-molded into the housing 310 and the base portion 20. In this way, the configuration shown in FIG. 9 other than the bearing holder 141 is formed. In other words, the housing 310, the base portion 20 and the casing 12 are integrally formed, and the contact 320 and the connection conductor 50 are arranged within the housing 310 and the base portion 20.

Then, in the connection step, the stator 14 of the motor 11 and the connection conductor 50 are electrically connected together. Specifically, the stator 14 which is previously produced is mounted on the base portion 20. Then, the printed board 16 and the connection conductor 50 are electrically connected together by, for example, soldering. In other words, the configuration shown in FIG. 12 is formed.

Then, in the rotor attachment step, the rotor 15 that includes the rotary shaft 13 to which the bearing 17 is attached and the blades 18 are attached to the stator 14. In this way, it is possible to manufacture, for example, the fan unit 1 shown in FIG. 6.

According to the method of manufacturing the fan unit 1 in the present embodiment, for example, the following effects are produced.

(8) The molding step is performed after the coating step. The connection step is performed after the molding step. In this way, it is possible to manufacture the fan unit 1 even by another manufacturing method.

### Ninth Embodiment

A fan unit 1 according to a ninth embodiment of the present invention will then be described with reference to FIGS. 13 to 15. The fan unit 1 according to the present embodiment has a feature in the shape of the fan 10.

As shown in FIGS. 13 to 15, the casing 12 includes a frame portion 122, a disc portion 123 and a stay 124. The frame portion 122 is arranged so as to surround the outer periphery of a plurality of blades 18.

The disc portion 123 is provided on the side of the stator 14 (the Z2 side). Specifically, the disc portion 123 is arranged so as to be overlaid on the printed board 16 in the Z direction.

The stay 124 is extended out in a radial direction from the outer peripheral edge portion of the disc portion 123, is connected to the frame portion 122 and is arranged on the upstream side with respect to the blades 18 in a blowing direction F of the gas. The surface of the stay 124 on the upstream side is inclined with respect to the direction of an axis line. Here, at least one of the disc portion 123 and the stay 124 includes an inclination portion 125 which is inclined outward in the radial direction toward a side opposite to the blowing direction F of the gas.

The rotor 15, the stator 14 and the printed board 16 can be formed by combining, as necessary, for example, a conventional technology disclosed in Japanese Unexamined Patent Application, Publication No. 2014-136997 and known technologies described in examples. The casing 12 can also be formed by combining, as necessary, the conventional technology disclosed in Japanese Unexamined Patent Application, Publication No. 2014-136997 and the known technologies described in examples.

According to the fan unit 1 of the present embodiment, for example, the following effects are produced.

(9) A rotor 15 of the motor 11 is formed with a bottom-equipped cylindrical portion 151 that is rotated about an axis line and that is arranged by insertion of a stator 14, and the fan 10 includes a plurality of blades 18 which are provided so as to protrude in a radial direction from an outer peripheral surface of the bottom-equipped cylindrical portion 151 and which are aligned in a peripheral direction of the bottom-equipped cylindrical portion 151. The casing includes: a frame portion 122 which surrounds the outer periphery of the blades 18; a disc portion 123 which is provided on the side of the stator 14; and a stay 124 which is extended out in the radial direction from an outer peripheral edge portion of the disc portion 123, is connected to the frame portion 122 and is arranged on an upstream side with respect to the blades 18 in a blowing direction F of a gas. In this way, it is possible to suppress the deposition and the entrance of a stain and the like on the stay 124 on the side of the blades 18 and between the rotor 15 and the stator 14, and thus it is possible to suppress the inhibition of the rotation of the fan 10 caused by the stain. Hence, it is possible to enhance the reliability of the fan 10.

(10) At least one of the disc portion 123 and the stay 124 includes an inclination portion 125 which is inclined outward in the radial direction toward a side opposite to the blowing direction F of the gas. In this way, a liquid such as oil adhered to the downstream side of the stay 124 can be made to flow outward in the radial direction, and thus it is possible to suppress solidification between the rotor 15 and the stator 14, with the result that it is possible to more enhance the reliability of the fan 10.

(11) A surface of the stay 124 on the upstream side is inclined with respect to the direction of the axis line. In this way, as compared with a case where the surface perpendicularly intersects the direction of the axis line, it is possible to smooth the flow of the gas flowing through the stay 124 to the blades 18. Hence, it is possible to enhance the air volume characteristic of the fan 10 and to reduce noises.

### Tenth Embodiment

A motor drive device 80 according to a tenth embodiment of the present invention will then be described with reference to FIGS. 16 to 18. The motor drive device 80 of the present embodiment includes the fan unit 1 according to the first to fifth embodiments and the ninth embodiment. The motor drive device 80 includes a motor drive device main body 90 to which the fan unit 1 is removably attached.

As shown in FIGS. 16 to 18, the motor drive device main body 90 includes a first body 91, a second body 92 and a separation member 93. The first body 91 is formed substantially in the shape of a rectangular parallelepiped. Within the first body 91, for example, a printed board (unillustrated) is arranged. The separation member 93 in which an opening 94 is formed is connected to one end surface of the first body 91. The first body 91 is arranged on the side of one surface of a power magnetics cabinet 96. Specifically, the first body 91 is arranged such that the end surface on which the separation member 93 is provided is directed to the side of the power magnetics cabinet 96. The first body 91 is fixed to an opening P of the power magnetics cabinet 96 through the separation member 93. The separation member 93 separates the side of the one surface of the power magnetics cabinet 96 (space L) and the side of the other surface (space K). The opening 94 of the separation member 93 is arranged in a state where the side of the one surface of the power magnetics cabinet 96 can communicate with the side of the other surface. In other words, the opening 94 of the separation member 93 is arranged so as not to be closed by the power magnetics cabinet 96. Although FIG. 18 shows that the power magnetics cabinet 96 and the separation member 93 are brought into contact with each other so as to be fixed, there is no limitation to this configuration. The power magnetics cabinet 96 and the separation member 93 may be fixed through a separate attachment plate.

The second body 92 is arranged substantially in the shape of a rectangular parallelepiped. The heatsink 95 is arranged outside the second body 92. The second body 92 is arranged adjacent to the separation member 93 in the first body 91. In other words, the second body 92 is arranged on the side of the other surface of the power magnetics cabinet 96. Within the second body 92, for example, a power element (unillustrated) which generates heat is arranged. The configurations of the motor drive device main body 90, the power magnetics cabinet 96 and the attachment plate described above can be formed by combining, as necessary, a conventional technology disclosed in Japanese Patent No. 4734299 and the known technologies described in examples.

The motor drive device 80 described above is operated as follows. The power magnetics cabinet 96 (and the attachment plate) partitions a space into the relatively clean space L and a relatively dirty space K which is made dirty by oil or the like. The motor drive device main body 90 is previously fixed to the power magnetics cabinet 96. Here, the first body 91 is arranged in the relatively clean space L. The second body 92 is arranged in the relatively dirty space K.

The first portion 21 and the fan 10 in the fan unit 1 are inserted through the opening 94 of the separation member 93 from the side of the first body 91 to the side of the second body 92. Then, the first portion 21 and the fan 10 are inserted until the second portion 22 is brought into contact with the surface of the separation member 93 on the side of the first body 91. In this way, the fan 10 is adjacent to the heatsink 95. Then, the contact 320 is arranged on the side of the first body 91. The second portion 22 closes the opening 94 of the separation member 93.

According to the motor drive device 80 of the present embodiment, for example, the following effects are produced.

(12) In the motor drive device 80 of the present embodiment, the fan unit 1 is inserted into the opening 94 of the separation member 93 from the side of the one surface of the power magnetics cabinet 96 (where the operation is easily performed), and thus the fan 10 can be arranged in a position capable of cooling the heatsink 95. When the fan unit 1 is replaced, the fan unit 1 inserted into the opening 94 is removed from the side of the one surface of the power magnetics cabinet 96, and thus the fan unit 1 can be replaced. In this way, it is possible to easily fit and remove the fan unit 1 to and from the motor drive device main body 90. The second portion 22 closes the opening 94 of the separation member 93, and thus it is possible to suppress the distribution of the gas in the side of the first body 91 (the gas in the space L) and the gas in the side of the second body 92 (the gas in the space K) through the opening 94.

Although the preferred embodiments of the fan unit, the method of manufacturing the fan unit and the motor drive device in the present invention have been described above, the present invention is not limited to the embodiments described above, and can be changed as necessary.

For example, although in the embodiments described above, the second portion 22 is extended vertically from the first portion 21, there is no limitation to this configuration. For example, the second portion 22 may be extended from the first portion 21 at an appropriate angle so as to correspond to the shape of the attachment of the motor drive device main body 90 (the shape of the separation member 93).

In the embodiments described above, the blowing direction F may be changed by attaching the fan 10 in the opposite direction in the Z direction.

Although in the embodiments described above, one fan unit 1 is attached to the side of the second body 92 in the motor drive device main body 90, there is no limitation to this configuration. A structure may be adopted in which the fan unit 1 can be further attached to the side of the first body 91.

### EXPLANATION OF REFERENCE NUMERALS

1 fan unit
10 fan
11 motor
12 casing
14 stator
15 rotor
18 blade
20 base portion
30 connector portion
40 through hole
50 connection conductor
60 seal member
80 motor drive device
90 motor drive device main body
91 first body
92 second body
93 separation member
94 opening
95 heatsink
96 power magnetics cabinet
122 frame portion
123 disc portion
124 stay
125 inclination portion
151 bottom-equipped cylindrical portion
310 housing
320 contact
F blowing direction
R resin

What is claimed is:

1. A fan unit comprising: a fan which includes a motor and a casing;
a base portion to which the fan is fixed by fixing of the casing; and
a connector portion which can be connected to an external terminal for supplying power to the motor and which includes a conductive contact and a housing that is formed integrally with the base portion.

2. The fan unit according to claim 1, wherein the casing is formed integrally with the base portion.

3. The fan unit according to claim 1 further comprising: a through hole which penetrates the base portion; and
a connection conductor which is passed through the through hole so as to electrically connect the contact and the motor together,
wherein the fan unit has a seal structure in which the through hole is sealed in a state where the connection conductor is passed through the through hole.

4. The fan unit according to claim 3, wherein the seal structure includes a seal member which seals the through hole in the state where the connection conductor is passed through the through hole.

5. The fan unit according to claim 1 further comprising a connection conductor which electrically connects the contact and the motor together and which is insert-molded into the base portion.

6. The fan unit according to claim 1, wherein the motor includes a rotor and a stator, and
at least part of a surface of the stator is coated with a resin.

7. A method of manufacturing a fan unit that includes: a fan which includes a motor and a casing; a base portion to which the fan is fixed by fixing of the casing; a connector portion which can be connected to an external terminal for supplying power to the motor and which includes a conductive contact and a housing that is formed integrally with the base portion; and a conductive connection conductor which connects the contact and the motor together, the method comprising:
a molding step of insert-molding the contact and the connection conductor into the base portion and the housing;
a connection step of electrically connecting a stator of the motor and the connection conductor together; and
a coating step of coating at least part of a surface of the stator with a resin.

8. The method of manufacturing the fan unit according to claim 7, wherein the connection step is performed after the molding step, and
the coating step is performed after the connection step.

9. The method of manufacturing the fan unit according to claim 7, wherein the coating step is performed after the connection step, and
the molding step is performed after the coating step.

10. The method of manufacturing the fan unit according to claim 7, wherein the connection step is performed after the coating step and the molding step.

11. The fan unit according to claim 1, wherein the motor includes a rotor which is formed with a bottom-equipped cylindrical portion that is rotated about an axis line and that is arranged by insertion of a stator,
the fan includes a plurality of blades which are provided so as to protrude in a radial direction from an outer peripheral surface of the bottom-equipped cylindrical portion and which are aligned in a peripheral direction of the bottom-equipped cylindrical portion and
the casing includes:
a frame portion which surrounds an outer periphery of the blades;
a disc portion which is provided on a side of the stator; and
a stay which is extended out in the radial direction from an outer peripheral edge portion of the disc portion, is connected to the frame portion and is arranged on an upstream side with respect to the blades in a blowing direction of a gas.

12. The fan unit according to claim 11, wherein at least one of the disc portion and the stay includes an inclination portion which is inclined outward in the radial direction toward a side opposite to the blowing direction of the gas.

13. The fan unit according to claim 11, wherein a surface of the stay on the upstream side is inclined with respect to a direction of the axis line.

14. A motor drive device comprising: the fan unit according to claim 1; and
a motor drive device main body to which the fan unit is removably attached.

15. The motor drive device according to claim 14, wherein the motor drive device main body includes:
a first body which is arranged on a side of one surface of a power magnetics cabinet;
a second body which is arranged on a side of the other surface of the power magnetics cabinet, which is aligned with the first body and which a heatsink is arranged outside; and
a separation member which separates the side of the one surface of the power magnetics cabinet and the side of the other surface of the power magnetics cabinet and which has an opening,
the base portion to which the fan is fixed is arranged adjacent to the heatsink in a state where the base portion is inserted from a side of the first body into the opening and
the housing is arranged on the side of the one surface of the power magnetics cabinet.
